(19) United States
(12) Patent Application Publication
(10) Pub. No.: US 2003/0202107 A1
(43) Pub. Date: Oct. 30, 2003

(54) Automated camera view control system

(76) Inventor: E. Michael Slattery, Everett, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/425,466

(22) Filed: Apr. 28, 2003

Related U.S. Application Data
(60) Provisional application No. 60/377,031, filed on Apr. 30, 2002.

(51) Int. Cl. H04N 5/225

(52) U.S. Cl. 348/207.99

(57) ABSTRACT

An apparatus used to control the position or selection of a video camera using a plurality of audio and logic inputs. These inputs are intelligently monitored by a microprocessor to determine the location of a person speaking and instruct a video camera to said location. Pluralities of operational modes are used by the apparatus to create a template of actions in determining the camera's position. Expandability is provided by adding a second, third or up to n expansion devices.

This application claims the priority of the provisional patent application No. 60/377,031 entitled Automated Camera View Control System filed on Apr. 30, 2000 which is incorporated by reference.

### BACKGROUND OF THE INVENTION

This invention pertains to meeting facilities requiring a video camera to be automatically positioned on a person speaking. The technical term for this type of system is “video follows audio” or “video-follows-audio” camera switching. Camera switching is defined as either a camera being positioned to a location by a pan and tilt control base or multiple cameras being positioned to multiple fixed locations where a video switcher is used to select a camera. These types of systems are typically used with videoconferencing and can be found in conference centers, boardrooms, council chambers and distance learning classrooms. Mostly, the invention pertains to a microprocessor controlled automated camera system that determines the position of a camera derived from selectable operational modes using the actions from its audio and logic inputs.

There are various types of video-follows-audio camera switching systems. The type of system depends on its application. Boardrooms generally use an automated system that determines the camera's position based upon a person speaking at a microphone. Current systems using this type of application generally require a control system with complex software monitoring the logic outputs from an automatic microphone mixer. When one speaks at a microphone, the logic output associated for this microphone instructs the control system to select a camera position for this microphone. To improve camera switching, delays are typically added in the control software to restrict abrupt camera changes.

Large distance learning classrooms are becoming popular and always require some form of a video-follows-audio camera switching system. For this type of system two or three students generally share a five-wire “push-to-talk” microphone. This type of microphone has three wires dedicated for the microphone and two wires dedicated for the talk-button. A control system monitors the status of the talk-button and, when pressed, the control system instructs the audio system to open the microphone's audio channel and select a camera for this position. When the talk-button is released, the control system instructs the audio system to mute the microphone's audio channel and select a default camera for this position. A default camera is generally set to a wide angle view of the classroom.

To implement these types of systems the designer must be fairly skilled and extensive software must be written for the control system. An automated camera system that can implement the above mentioned systems using selectable modes is needed to improve the performance and installation of these types of systems.

### SUMMARY OF THE INVENTION

The invention disclosed and claimed within incorporates a method and apparatus for implementing a video-follows-audio camera switching system. A plurality of analog audio and binary logic inputs are monitored by the intelligence of a programmed microcontroller operating in selectable modes to determine the location of a person who is speaking or wants to speak. When said location is determined, the apparatus communicates the detected location to an external device through a data interface and a plurality of binary logic outputs.

In one embodiment, expandability is accommodated by a second, third, or up to n expansion devices each having a plurality of microphone audio and binary logic inputs, a plurality of logic outputs and a data bus communications interface to all other devices on said data bus. Each expansion device contains a slave microcontroller that monitors the analog audio and binary logic inputs and reports their status to the master microcontroller.

The embodiment also may include a controller unit containing the master microcontroller, a program audio input, a plurality of microphone audio and binary logic inputs, a plurality of binary logic outputs, a data communications interface to a room control system, a data communications interface to a personal computer, and a data bus communication interface to all other devices on the data bus.

In one embodiment of the controller unit, the master microcontroller maintains operability of the apparatus. The microcontroller monitors the program audio input, the microphone audio and binary logic inputs on the controller unit and establishes communications to the expansion devices, room controller and personal computer. System information is stored in the master microcontroller and transferred to the expansion devices.

The microphone audio inputs are high impedance allowing for connecting microphones to both the described apparatus and a microphone mixer. These inputs are monitored via an analog to digital interface by the microcontrollers.

In another embodiment, selectable modes are used to change the operation of the apparatus. These modes include automatic microphone, automatic logic, push-to-talk (three-wire), push-to-talk (five-wire), push-to-talk (five-wire) with automatic microphone, push-to-activate and custom.

### BRIEF DESCRIPTION OF THE DRAWINGS

The preceding and other features of the present invention are more fully appreciated when considered in light of the following specifications and drawings in which:

FIGS. 1 and 1A are collectively a representative diagram of an exemplary automated camera system according to an embodiment of the invention.

FIGS. 2 and 2A are collectively a detailed block diagram of one of the components in FIG. 1 called the controller unit that includes the programmed master microcontroller according to an embodiment of the invention.

FIG. 3 is a detailed block diagram of one of the components in FIG. 1A called the expansion unit that includes the programmed slave microcontroller according to an embodiment of the invention.

FIG. 4 illustrates a flowchart of the automatic microphone mode according to an embodiment of the invention.

FIG. 5 illustrates a flowchart of the automatic logic mode according to an embodiment of the invention.

FIGS. 6 and 6A collectively illustrates a flowchart of the (three-wire) push-to-talk mode according to an embodiment of the invention.

FIG. 7 illustrates a flowchart of the (five-wire) push-to-talk mode according to an embodiment of the invention.

FIGS. 8 and 8A collectively illustrates a flowchart of the (five-wire) push-to-talk with automatic microphone mode according to an embodiment of the invention.

FIGS. 9 and 9A collectively illustrates a flowchart of the push-to-Activate mode according to an embodiment of the invention.

### DETAILED DESCRIPTION OF THE INVENTION

From the foregoing it will be appreciated that, although specific embodiments of the invention have been described herein for purposes of illustration, various modifications may be made without deviating from the spirit and scope of the invention.

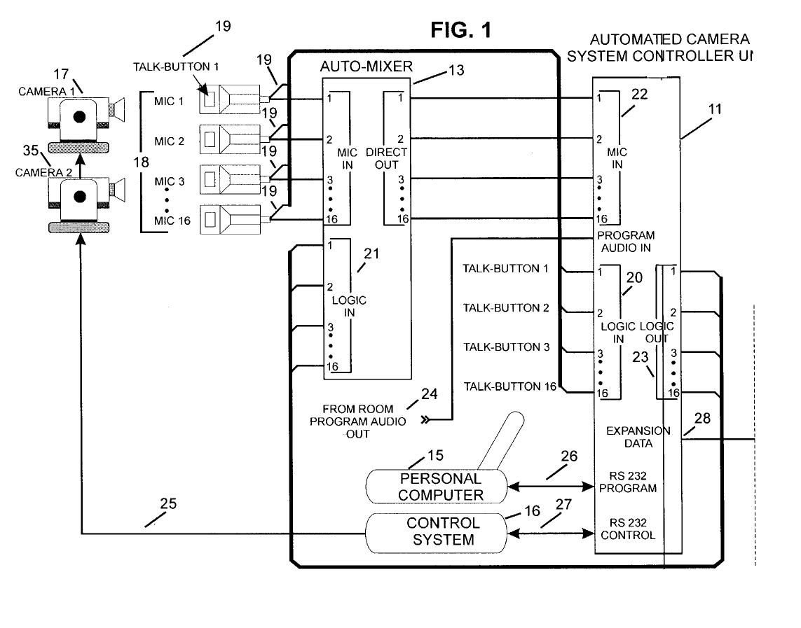

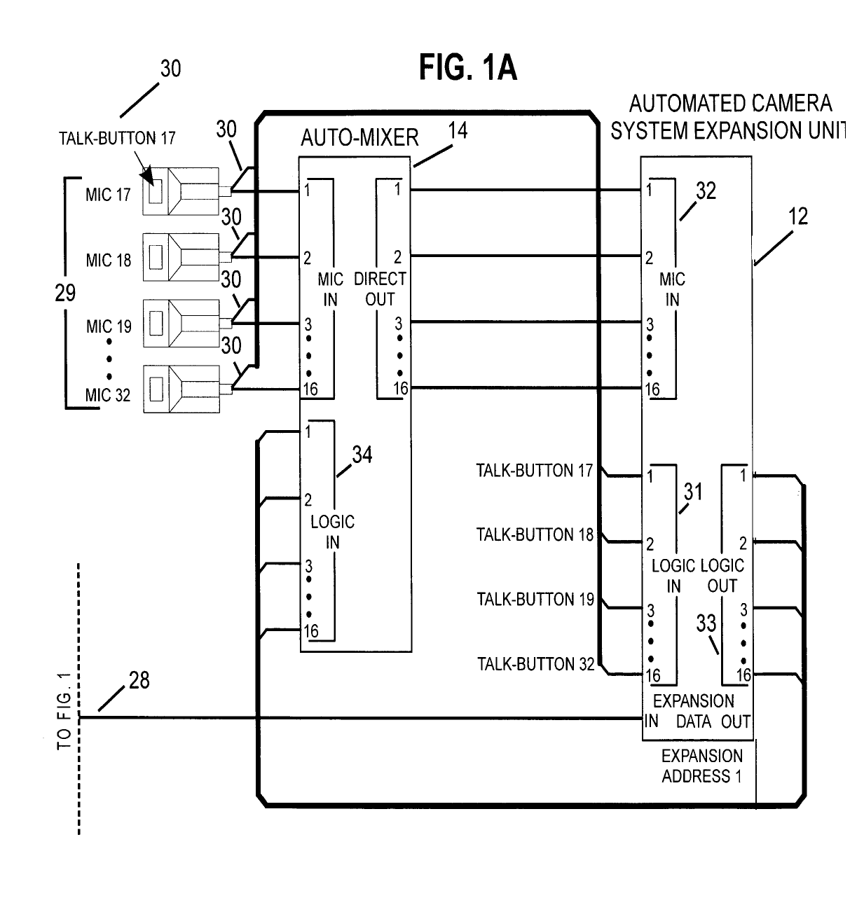

An exemplary automated camera system incorporating the integration of components to the present invention is illustrated in FIG. 1 and includes a controller unit 11, expansion unit 12, automatic microphone mixers 13 and 14 and (five-wire) push-to-talk microphones 18 and 29 that are always live. The controller unit 11 includes a master microcontroller to maintain the operational modes and direct traffic between the personal computer 15, the room controller 16 and the expansion unit 12. Included in the controller unit are sixteen microphone inputs 22 shown here connected to the direct outputs from an automatic microphone mixer 13, a program audio input connected to a room program audio output 24, sixteen logic inputs 20 connected to the talk-button 19 on microphones 18 and sixteen logic outputs 23 connected to the logic inputs 21 on the automatic mixer 13.

An expansion unit 12 is added to increase the number of microphone inputs to thirty-two on the integrated system illustrated in FIG. 1 by connecting the direct outputs of a second automatic microphone mixer 14 to the microphone inputs 32 on expansion unit 12. The expansion unit 12 includes a slave microcontroller to receive program and status information from the controller unit 11 via an expansion data bus 28 and maintain the operational modes. Included in the expansion unit 12 are sixteen microphone inputs 32 shown here connected to the direct outputs from an automatic microphone mixer 14, sixteen logic inputs 31 connected to the talk-button 30 on microphones 29 and sixteen logic outputs 33 connected to the logic inputs 34 on the automatic mixer 14.

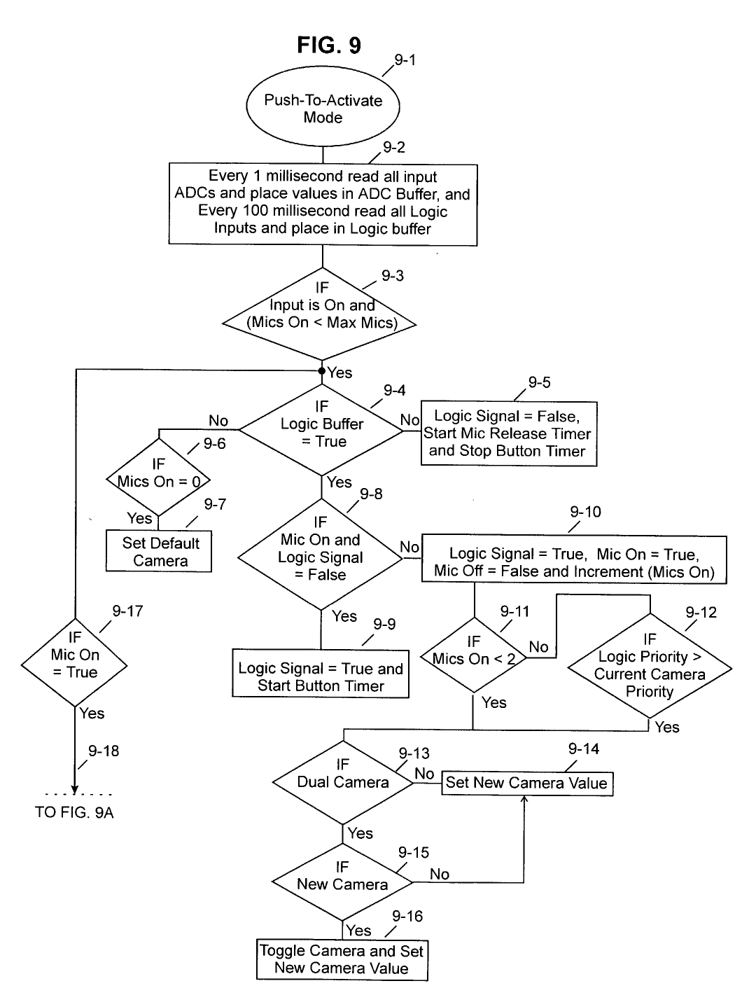

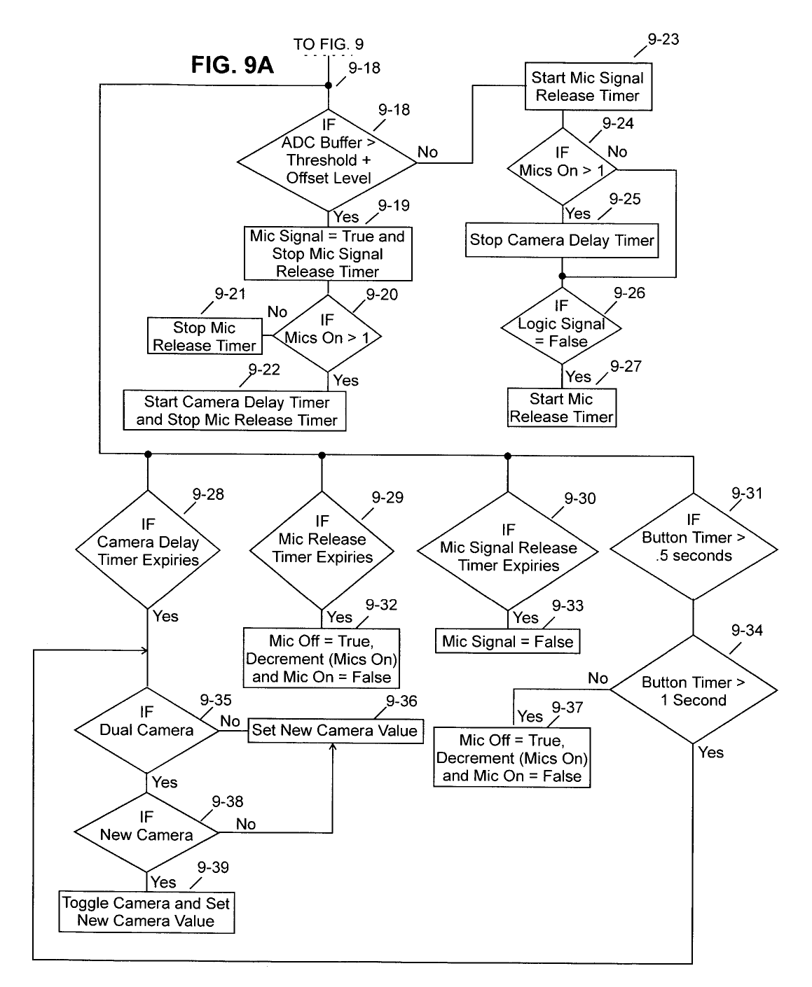

The exemplary automated camera system to the present invention as illustrated in FIG. 1 may be operated in a push-to-activate mode 9-1 as shown in the flowchart FIG. 9. To select the operational mode the controller unit 11 may first be programmed by a personal computer 15 via an RS 232 data connection 26. The actions of the push-to-activate mode are as follows: At the beginning, there are no talk-buttons pressed, the number of microphones on is set to zero, the microphone audio inputs 22 are tested for audio level by ADCs every one millisecond 9-2, the logic inputs are read every hundred millisecond 9-3, the input is set to on 9-5 and inputs one through sixteen are tested 9-4. Pressing talk-button 19 on microphone one 18 causes a logic true 9-6 condition at logic input one 20 on the controller unit 11. The master microcontroller in the controller unit 11 detects the pressing of the talk-button 19 when the logic buffer for this input is true 9-6. This action produces a true logic signal, sets the microphone on to true, sets the microphone off to false, increments the number of microphones on 9-10 to one and enables logic output number one 23. Since the number of microphones on is less than two 9-11, the new camera value is set to the detected input, one in this case 9-12. If more than one microphone is on 9-11, and the logic priority for this logic input 21 is greater than the current camera priority 9-13, this input becomes the new camera position 9-14.

As illustrated in FIG. 1, the logic outputs 23 on the controller unit 11 are connected to the logic inputs 21 on the automatic microphone mixer 13 allowing the controller unit 11 to un-mute or mute individual microphones on the automatic microphone mixer 13. Since logic output number one 23 is enabled, the logic input for microphone one 21 is also enabled un-muting microphone one on the automatic microphone mixer 13.

Once a microphone input 22 is determined to be on 9-15, the microphone input 22 is tested for speech by the ADC buffer being greater than the sum of the threshold level and the offset level 9-16. If speech is detected, the microphone signal is set to true and the microphone signal release timer is stopped 9-17. Since only one microphone is currently on 9-18, only the microphone release timer is stopped 9-19. If more than one microphone happens to be on, a camera delay timer is started and the microphone release timer is stopped 9-20. If the camera delay timer expires 9-26, the current microphone input is set as the camera value 9-27.

Releasing the talk-button 19 on microphone one 18 causes a logic false 9-6 condition at logic input one 20 on the controller unit 11. The master microcontroller in the controller unit 11 detects the releasing of the talk-button 19 when the logic buffer for this input goes false 9-6. This action produces a false logic signal and starts the microphone release timer 9-7. As long as speech is detected at the ADC buffer 9-16 and the microphone release timer does not expire 9-28, microphone one remains active. If speech is not detected by the ADC buffer 9-16, the microphone signal release timer is started 9-21. Since only one microphone is currently on 9-22 and the logic signal is false 9-24, the microphone release timer is started 9-25. If more than one microphone happens to be on 9-22, the camera delay timer is stopped 9-23. If the microphone signal release timer expires 9-30, the microphone signal is set to false 9-31. If the microphone release timer expires 9-28, microphone off is set to true, microphone on is set to false and microphones on is decremented 9-29. If microphones on equals zero 9-8, the default camera is selected 9-9.

The new camera value 9-12, 9-14 or 9-27 or the default camera 9-9 is transmitted to the control system 16 via an RS 232 connection 27. This new camera value is then processed by the control system 16. The control system 16 then sends a command through a data cable 25 to position the camera 17. Control systems are commercially available from AMX, Crestron and other suppliers.

The controller unit 11 as featured in the embodiment of FIG. 1 includes a preprogrammed master microcontroller with user defined operational parameters. The expansion unit 12 has a preprogrammed slave microcontroller with user defined applications configured via the master microcontroller. The controller unit 11 accepts user defined operating parameters from an external personal computer 15. Operational parameters are processed by the master microcontroller where they are then assigned to appropriate slave microcontrollers. During system setup, a personal computer 15 is connected to the controller unit 11 via an RS 232 data connection allowing operating parameters to be transmitted to the master microcontroller. Once the controller is programmed, the personal computer 15 can be removed.

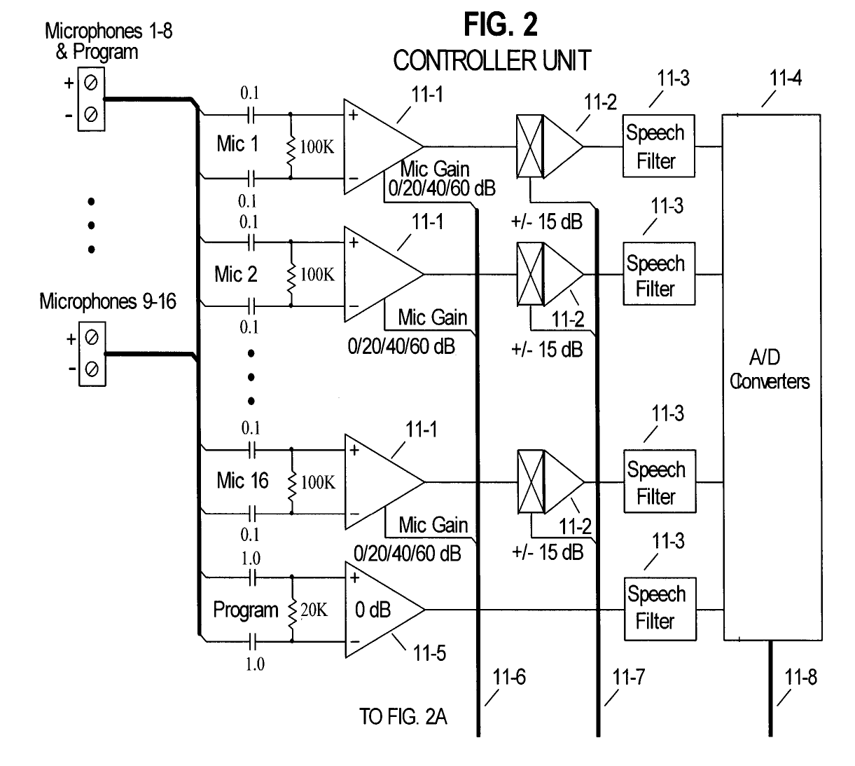

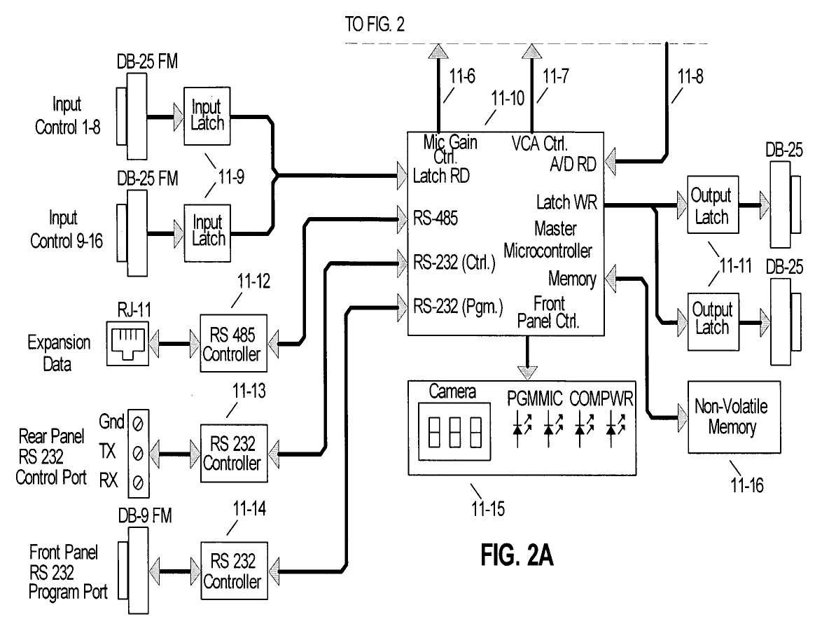

As shown in FIG. 2 the controller unit 11 is the master controller of the automated camera system including the expansion unit 12. During system setup, the operating parameters are programmed into the controller unit from a personal computer 15 via an RS 232 program data 26 connection. Data communications received on the RS 232 program data 26 connection are processed by an RS 232 controller 11-14. These operating parameters are stored in the controller unit 11 using non-volatile memory 11-16 and are processes by a master microcontroller 11-10. System communication between the controller unit 11 and the expansion unit 12 are processed through an RS 485 controller 11-12 using a serial data link 28.

For communicating to a control system 16, an RS 232 control data 27 connection is utilized. Having a separate RS 232 control connection 27 from the RS 232 program 26 connection allows for the control connection to use event driven communication techniques and simple command codes that are processed by the RS 232 controller 11-13. Event driven communication techniques allows the controller unit 11 to automatically broadcast system changes to the control system 16 without having the control system request the information. This improves the performance of the control system.

The controller unit 11 has an extra audio input that is not on the expansion unit 12 called program audio. This input is connected to the program audio 24 of the room and consist of all audio sources except local microphone reinforcement. Program audio is monitored for peak levels by the master microcontroller. The peak level value is then transmitted to all slave microcontrollers. This peak level value is used by all units to increase the microphone threshold detection when program audio is present. This reduces the chance of false detection at the microphones when audio sources are being played over the room loud speakers.

The controller unit consists of:

sixteen microphone pre-amps 11-1 with four levels of gain control (0, 20, 40 and 60 dB) 11-6;

voltage controlled amplifiers 11-2 with +/−20 dB of level control from a data bus 11-7;

speech filters 11-3 to remove frequencies that are not in the speech range;

analog to digital converters 114 controlled by a data bus 11-8 to sample the audio level from each microphone channel and the program channel inputs;

a program audio input 11-5;

sixteen logic inputs with latches 11-9;

master microcontroller 11-10 for processing all of the communications, and maintaining the operation of the system;

sixteen logic outputs with latches 11-11;

expansion data bus using an RS 485 serial data bus processed though an RS 485 controller 11-12;

RS 232 program port processed by an RS 232 controller 11-14 to communicate to an external personal computer using serial data;

RS 232 control port processed by an RS 232 controller 11-13 to communicate to an external control system using serial data;

A front panel led display 11-15 including a three segment display for the camera position, an indicator for program audio detection, an indicator for microphone audio detection, a communications indicator and a power indicator;

non-volatile memory 11-16 to store system parameters.

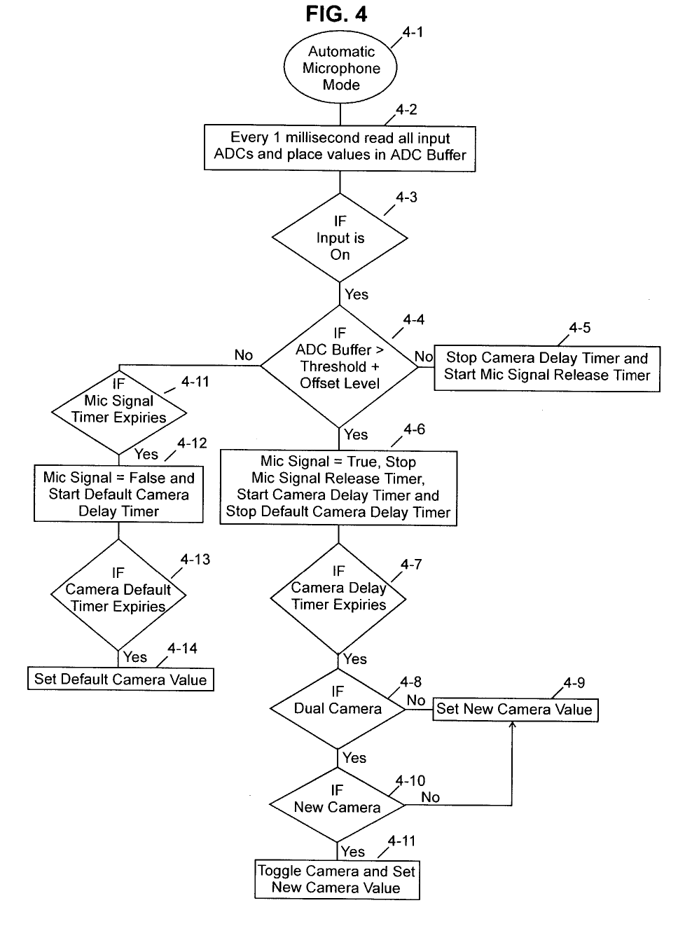

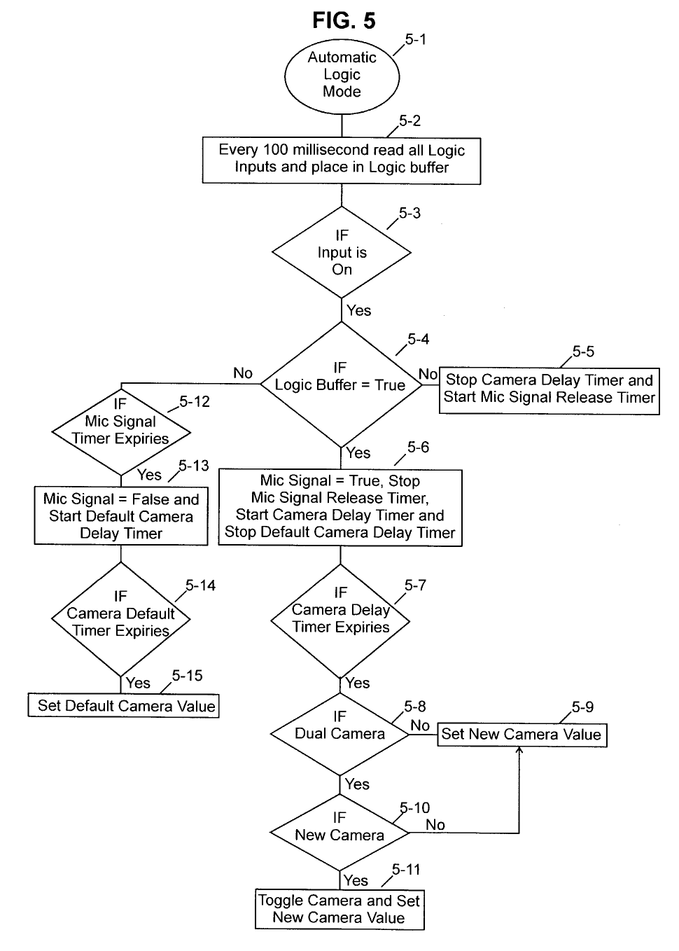

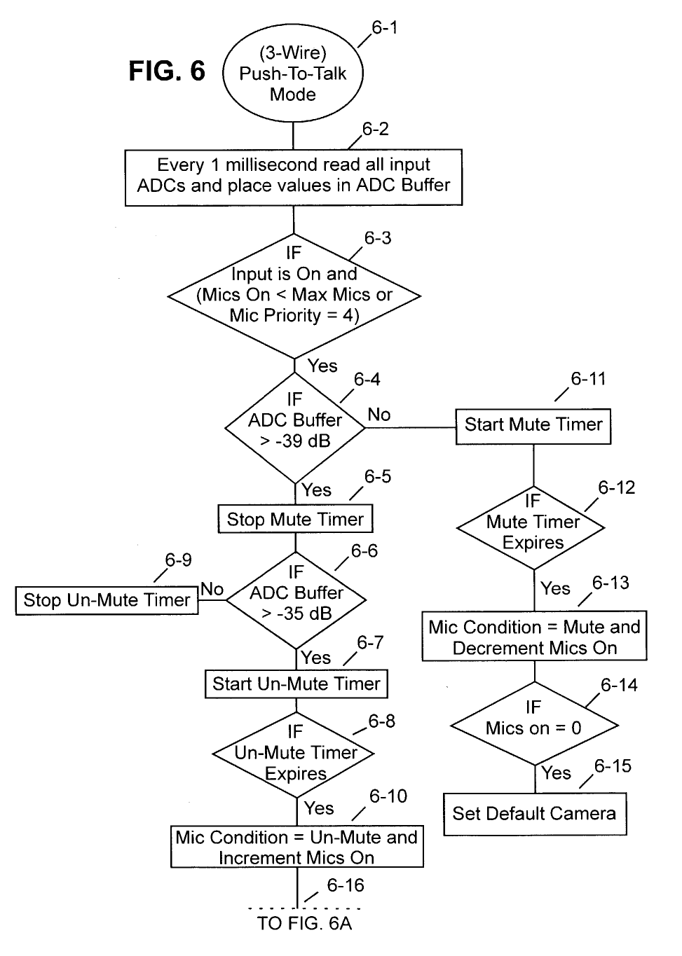

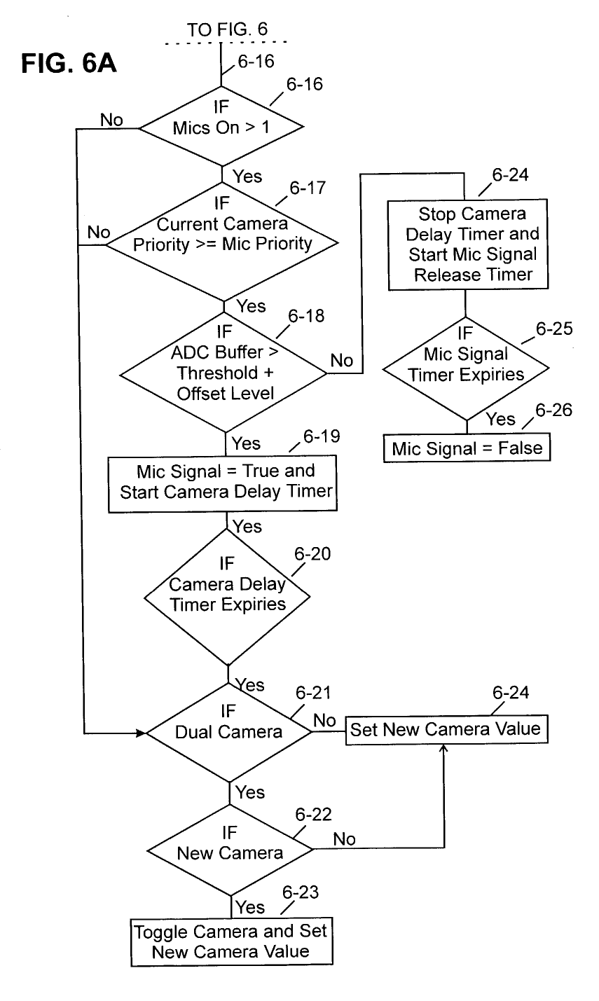

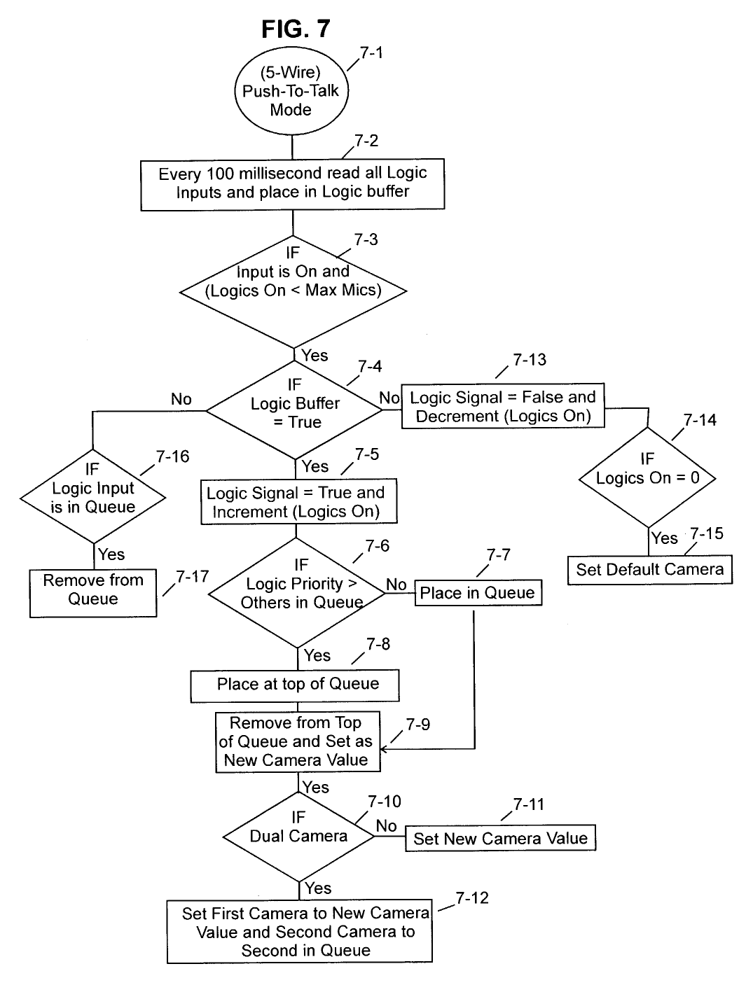

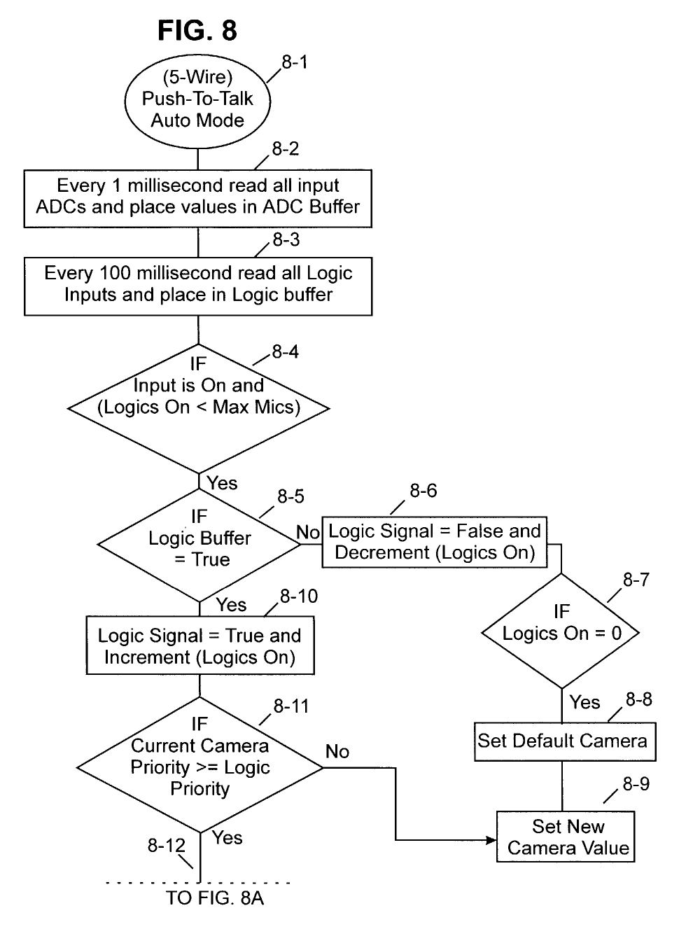

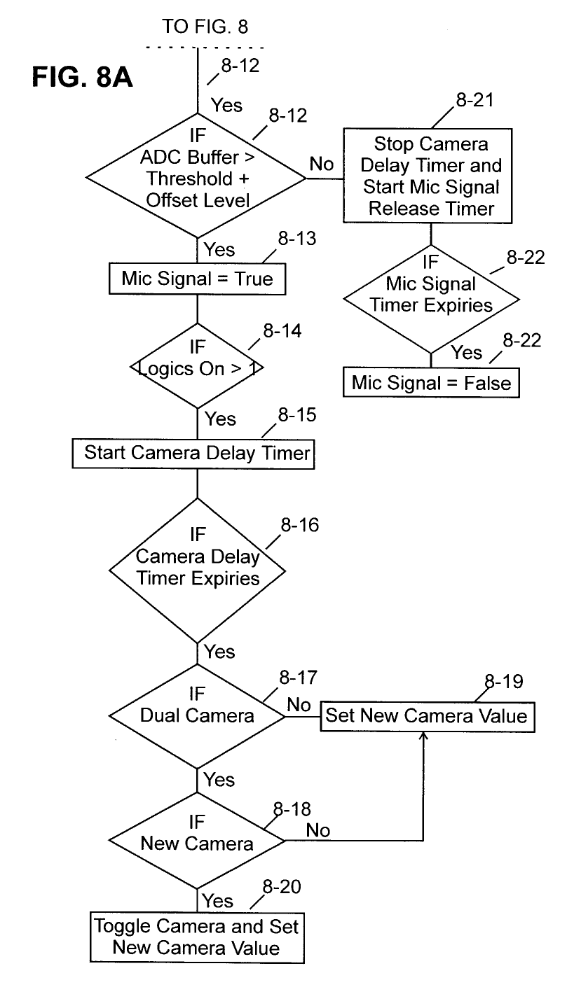

During programming of the controller unit, an operational mode is selected to determine how the automated camera system responds to external sources. These modes include automatic microphone (FIG. 4), automatic logic (FIG. 5), push-to-talk (three-wire) (FIG. 6), push-to-talk (five-wire) (FIG. 7), push-to-talk (five-wire) with automatic microphone (FIG. 8), push-to-activate (FIG. 9) and custom (not shown in any fig.)

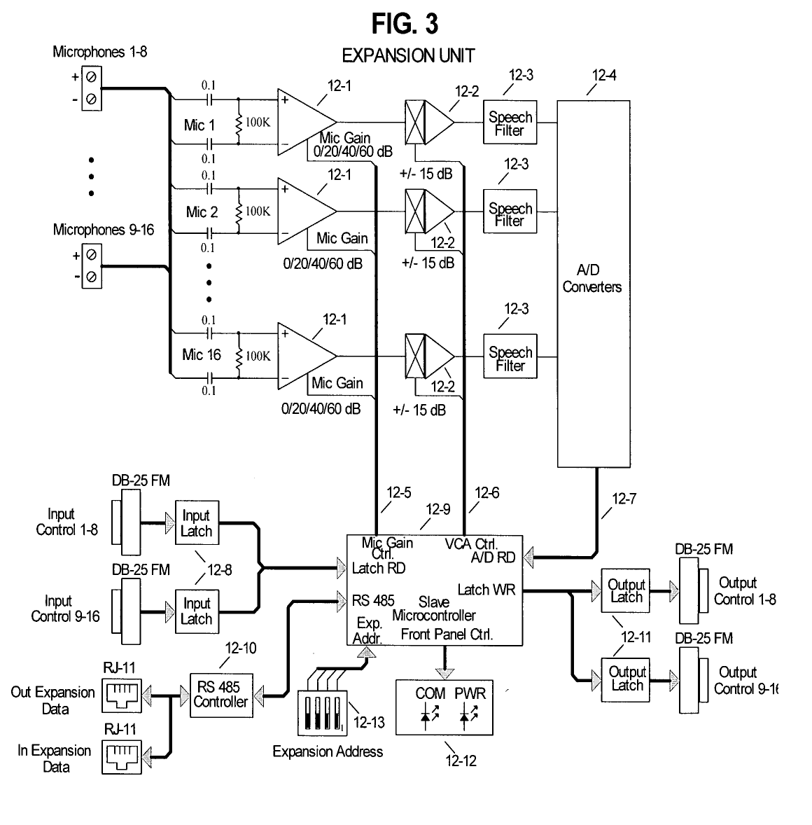

As shown in FIG. 3 the expansion unit 12 is a slave to the controller unit 11 of the automated camera system. The purpose of the expansion unit 12 is to increase the number of microphone and logic inputs. The expansion unit 12 will not operate by itself and must be connected to a controller unit 11. During system reset, the master microcontroller transmits its stored operational parameters to all slave microcontrollers via an RS-485 serial link 28.

The expansion unit consists of:

sixteen microphone pre-amps 12-1 with four levels of gain control (0, 20, 40 and 60 dB) 12-5;

voltage controlled amplifiers 12-2 with +/−20 dB of level control from a data bus 12-6; speech filters 12-3 to remove frequencies that are not in the speech range;

analog to digital converters 12-4 controlled by a data bus 12-7 to sample the audio level from each microphone channel and the program channel inputs;

sixteen logic inputs with latches 12-8;

slave microcontroller 12-9 for processing communications from the controller unit 11, and maintaining the operation of the system;

sixteen logic outputs with latches 12-11;

in and an out expansion data bus using an RS 485 serial data bus processed though an RS 485 controller 12-10;

A front panel led display 12-12 including a communications indicator and a power indicator;

expansion address data switch 12-13 is used to set the slave address of the expansion unit 12.

As illustrated in FIG. 4, the automatic microphone mode 4-1 only monitors the microphone inputs. The logic inputs are disabled during this mode of operation. The purpose of the automatic microphone mode is to detect a person speaking at a microphone position and automatically switch a camera to this position. To improve the camera transitions and reduce the possibility that multiple microphones may be detected at the same time causing the camera to radically switch back-and-forth, a camera delay is used. A default camera position may also be used to show a wide angle view of the room when speech has not been detected for set amount of time.

Every one millisecond the microcontroller reads each ADC level and places the level into an ADC buffer 4-2. Each of the sixteen microphone inputs are then tested 4-3 for their operational status. If the tested microphone input is on 4-4, the level for this microphone in the ADC buffer is compared to a set threshold level plus an offset level 4-5. The offset level is a sum of the peak program level and the peak level of the current detected microphone. Using this type of offset improves the microphone detection by reducing the chance for a false detection when audio is present at the room loud speakers or someone is talking at another microphone.

If the level of the microphone under test placed in the ADC buffer is greater than the set threshold level plus an offset level 4-5, then speech is detected at this microphone and the microphone signal status is set to true, a camera delay timer is started and a default camera timer is stopped 4-7. If speech is continually detected for the duration of the camera delay timer 4-8, then the position of this microphone becomes the new camera position 4-9.

If the level of the microphone under test placed in the ADC buffer is less than the set threshold level plus an offset level 4-5, then speech is not detected at this microphone. Also, the microphone signal release timer is started and the camera delay timer is stopped 4-6. If the microphone signal release timer has been started and speech is continually not detected for the duration of the microphone release timer 4-10, then the microphone signal is set to false and a camera default timer is started 4-11. A continuation of not detecting speech for the duration of the camera default timer 4-12 results in a new camera position being set to the default camera position 4-13.

As illustrated in FIG. 5 the automatic microphone mode 5-1 only monitors the logic inputs. The microphone inputs are disabled during this mode of operation. The purpose of the automatic logic mode is to detect the logic output status from an automatic microphone mixer that is associated with a person speaking at a microphone position and automatically switch a camera to this position. To improve the camera transitions and reduce the possibility that multiple microphones may be detected at the same time causing the camera to radically switch back-and-forth, a camera delay is used. A default camera position may also be used to show a wide angle view of the room when speech has not been detected for set amount of time.

Every one-hundred millisecond the microcontroller reads each logic input and places the logic level into a logic buffer 5-2. Each of the sixteen logic inputs are then tested 5-3 for their operational status. If the tested logic input is on 5-4, the logic level within the logic buffer is tested for being true 5-4. If true, then speech is detected at this logic input and the microphone signal status is set to true, a camera delay timer is started and a default camera timer is stopped 5-7. If speech is continually detected for the duration of the camera delay timer 5-8, then the position of this microphone becomes the new camera position 5-9.

If the logic level of the logic input under test placed in the logic buffer is false 5-5, then speech is not detected at this logic input. A false condition for the logic buffer starts the microphone signal release timer and stops the camera delay timer 5-6. If the microphone release timer has been started and speech is continually not detected for the duration of the microphone release timer 5-10, then the microphone signal is set to false and a camera default timer is started 5-11. A continuation of not detecting speech for the duration of the camera default timer 5-12 results in a new camera position being set to the default camera position 5-13.

As illustrated in FIG. 6 the (three-wire) push-to-talk mode 6-1 only monitors the microphone inputs. The logic inputs are disabled during this mode of operation. The purpose of the (three-wire) push-to-talk mode is to detect the un-muting and muting of a microphone and to detect a person speaking at a microphone position, whereby a camera is automatically switched to the detected position. A limit to the maximum number of microphones that can be engaged at the same time can be set. Also, a microphone priority value can be set to allow microphone's with higher priority values to take the camera's position. Setting a microphone's priority value to four allows the microphone to ignore the limit of the maximum number of microphones that can be engaged. To improve the camera transitions and reduce the possibility that multiple microphones may be detected at the same time causing the camera to radically switch back-and-forth, a camera delay is used. A default camera is used to show a wide angle view of the room when all microphones are detected as muted.

Every one millisecond the microcontroller reads each ADC level and places the level into an ADC buffer 6-2. Each of the sixteen microphone inputs are then tested 6-3 for their operational status. A microphone is allowed to be tested If the microphone input is on 6-4, and if the number of microphones on is less than the set maximum microphone value or the microphone under test priority is four 64. If the microphone is allowed to be tested, it is first determined to muted or un-muted. A mute condition is made when the ADC buffer level is less than −38 dB 6-5 for five-hundred milliseconds 6-13. A mute timer is started 6-12 when the ADC buffer level is less than −38 dB 6-5 and the mute timer is stopped 6-6 when the ADC buffer is greater than −39 dB 6-5. An un-mute condition is made when the ADC buffer level is greater than −35 dB 6-7 for one-hundred milliseconds 6-10. An un-mute timer is started 6-9 when the ADC buffer level is less than −38 dB 6-7 and the un-mute timer is stopped 6-8 when the ADC buffer is less than −36 dB 6-7. This two step process for determining a mute or un-mute condition adds hysteresis to improve the detection status. If the number of microphones on is not less than the set maximum microphone value, the microphone will not be tested unless its priority is set to four 6-4.

An un-muted microphone has its microphone condition set to un-mute and the number of microphones on is incremented 6-11. If the un-muted microphone is the only one on, determined by the number of microphones on being less than two 6-17, then this microphone becomes the new camera position 6-22. Otherwise, if the number of microphones on is greater than one 6-17, then the current camera priority is compared to the microphone priority 6-18. If the current camera priority is greater than or equal to the microphone priority 6-18, then microphone is tested for speech. Otherwise, the microphone becomes the new camera position 6-22.

When multiple microphones are determined to be on by the number of microphones on being greater than one 6-17, then the camera's position is determined by speech detection. Determining speech detection is made by comparing the ADC buffer to a set threshold level plus an offset level 6-19. The offset level is a sum of the peak program level and the peak level of the current detected microphone. Using this type of offset improves the microphone detection by reducing the chance for a false detection when audio is present at the room loud speakers or someone is talking at another microphone.

If the level of the microphone under test placed in the ADC buffer is greater than the set threshold level plus an offset level 6-19, then speech is detected at this microphone and the microphone signal status is set to true and a camera delay timer is started 6-20. If speech is continually detected for the duration of the camera delay timer 6-21, then the position of this microphone becomes the new camera position 6 22.

If the level of the microphone under test placed in the ADC buffer is less than the set threshold level plus an offset level 6-19, then speech is no longer detected at this microphone starting the microphone signal release timer and stopping the camera delay timer 6-23. If the microphone signal release timer has been started and speech is continually not detected for the duration of the microphone release timer 6-24, then the microphone signal is set to false 6-25.

When all microphones have become muted by the number of microphones on equal to zero 6-15, a default camera position is selected 6-16.

As illustrated in FIG. 7 the (five-wire) push-to-talk mode 7-1 only monitors the logic inputs. The microphone inputs are disabled during this mode of operation. The purpose of this mode is to detect the logic output status from a talk-button and switch a camera to this position. To improve the camera transitions and reduce the possibility that multiple talk-buttons may be detected at the same time causing the camera to switch to the last person to press the talk-button, a first-in-first-out queue is used. A default camera may also be used to show a wide angle view of the room when all talk-buttons are released.

Every one-hundred millisecond the microcontroller reads each logic input and places the logic level into a logic buffer 7-2. Each of the sixteen logic inputs are then tested 7-3 for their operational status. If the tested logic input is on 7-4, the logic level within the logic buffer is tested for being true 7-5. If true, then the pressing of a talk-button is detected at this logic input and the logic signal is set to true and the number of logics on is incremented 7-6.

If a talk-button is detected as being pressed, the priority of the logic input is compared with the priority of other active logic inputs already in the queue. If the priority of the logic input is greater than those that are already in the queue 7-7, then the logic input is placed at the top of the queue 7-9 where its is removed from the queue 7-10 and set as the new camera position 7-11. Otherwise, if the priority of the logic input is less than those that are already in the queue 7-7, then the logic input is placed at the bottom of the queue 7-8.

If the talk-button is released, then the compare of the logic buffer is false 7-5 causing the logic signal to be set to true and the number of logics on to be decremented 7-12. Since the logic was on 7-15, the next logic input in the queue 7-10 becomes the new camera position 7-11. If none of the logic inputs are on 7-13, then the default camera 7-14 is set as the new camera position 7-11.

As illustrated in FIG. 8 the (five-wire) push-to-talk automatic mode 8-1 monitors both the microphone and logic inputs. A microphone input is monitored once its corresponding logic input is enabled. The purpose of this mode is to detect the logic output status from a talk-button, switch a camera to this position. Also, if multiple talk-buttons are pressed, automatically select the camera's position by detecting a person speaking at a microphone. To improve the camera transitions and reduce the possibility that multiple microphones may be detected at the same time causing the camera to radically switch back-and-forth, a camera delay is used. A default camera position may also be used to show a wide angle view of the room when speech has not been detected for set amount of time.

Every one millisecond the microcontroller reads each ADC level and places the level into an ADC buffer 8-2. Also, every one-hundred millisecond the microcontroller reads each logic input and places the logic level into a logic buffer 8-3. Each of the sixteen logic inputs are then tested 8-4 for their operational status. A microphone input is allowed to be tested once a logic input is enabled.

If the tested logic input is on 8-5, the logic level within the logic buffer is tested for being true 8-6. If true, then the pressing of a talk-button is detected at this logic input setting logic signal true and incrementing the number of microphones on 8-10.

If a talk-button is detected as being pressed, the priority current camera position is compared with the priority of the tested logic input 8-11. If the priority of the current camera position is greater than or equal to the priority of the logic input 8-11, then the associated microphone input is monitored for speech detection. Otherwise, the logic input is selected as the new camera position 8-12.

If the level of the monitored microphone placed in the ADC buffer is greater than the set threshold level plus an offset level 8-13, then speech is detected at this microphone and the microphone signal status is set to true 8-14. If more than one microphone is on 8-15, then the camera delay timer is started 8-16. If speech is continually detected for the duration of the camera delay timer 8-17, then the position of this microphone becomes the new camera position 8-18.

If the level of the monitored microphone placed in the ADC buffer is less than the set threshold level plus an offset level 8-13, then speech is not detected at this microphone and the microphone signal release timer is started and the camera delay timer is stopped 8-18. If the microphone signal release timer has been started and speech is continually not detected for the duration of the microphone release timer 8-20, then the microphone signal is set to false.

If the talk-button is released, then the compare of the logic buffer is false 8-6 causing the logic signal to be set to false and decrementing the number of microphones on 8-7. If none of the logic inputs are on 8-8, then the default camera 8-9 is set as the new camera position 8-12.

I claim:

1. A video-follows-audio camera system comprising:
a plurality of audio-inputs, each operable to detect a signal from an audio input device;
a mode switch operable to set a mode for detecting each signal at the plurality of audio inputs; and
a controller coupled with the plurality of audio inputs and coupled with the mode switch, the controller operable to detect a signal from each of the plurality of audio-inputs and operable to control a camera based upon each detected signal and the mode set by the mode switch.

2. The system of claim 1, further comprising a mixer operable to mix the plurality of audio input signals.

3. The system of claim 1 wherein the mode switch is implemented via software and operable to be programmed by a personal computer.

4. The system of claim 1 wherein at least one mode operable to be set by the mode switch comprises an automatic microphone mode wherein the controller selects a view of the camera that corresponds with the audio input device that detects a signal.

5. The system of claim 1 wherein at least one mode operable to be set by the mode switch comprises an automatic logic mode wherein the controller selects a camera view that corresponds to a logic input derived from an audio signal from the audio input device.

6. The system of claim 1 wherein at least one mode operable to be set by the mode switch comprises a three-wire push-to-talk mode wherein the controller selects a camera view that corresponds to an audio input device that detects a signal and that is not muted.

7. The system of claim 5 wherein the controller selects a camera view that corresponds to the audio input device having a higher priority.

8. The system of claim 1 wherein at least one mode operable to be set by the mode switch comprises a five-wire push-to-talk mode wherein the controller selects a camera view that corresponds to a logic input derived from a pushbutton associated with an audio input device.

9. The system of claim 7 wherein the controller selects a camera view that corresponds to the audio input device having a higher priority.

10. The system of claim 1 wherein at least one mode operable to be set by the mode switch comprises a five-wire push-to-talk automatic mode wherein the controller selects a camera view in response to a receiving a continuous logic input corresponding to an audio input device and in response to a detecting a signal at the audio input device that is associated with the logic input.

11. The system of claim 1 wherein at least one mode operable to be set by the mode switch comprises a push-to-activate mode wherein the controller selects a camera view in response to a receiving a logic input of a limited duration corresponding to an audio input device and in response to a detecting a signal at the audio input device that is associated with the logic input.

12. A method for controlling a view of a camera in a video-follows-audio camera system, the method comprising:
positioning a view of a camera based upon a first mode and a plurality of detected audio input signals;
switching the camera system from the first mode to a second mode; and
positioning the view of the camera based upon the second mode and the plurality of detected audio input signals.

13. The method of claim 12 wherein positioning a view of the camera based upon a first mode further comprises:
detecting a first audio input signal from a first audio input device; and
positioning the view of the camera to a predetermined view that corresponds to the first audio input device.

14. The method of claim 12 wherein positioning a view of the camera based upon a first mode further comprises:
detecting a first logic signal derived from an audio input signal from a first audio input device; and
positioning the view of the camera to a predetermined view that corresponds to the first audio input device.

15. The method of claim 12 wherein positioning a view of the camera based upon a first mode further comprises:
detecting a first audio input signal from a first audio input device;
determining that the first audio input device is not muted; and
positioning the view of the camera to a predetermined view that corresponds to the first audio input device.

16. The method of claim 12 wherein positioning a view of the camera based upon a first mode further comprises:
detecting a first logic input signal derived from a logical switch associated with a first audio input device; and
positioning the view of the camera to a predetermined view that corresponds to the first audio input device.

17. The method of claim 12 wherein positioning a view of the camera based upon a first mode further comprises:
detecting a first continuous logic input signal derived from a logical switch associated with a first audio input device;
detecting a first audio input signal from the first audio input device; and
positioning the view of the camera to a predetermined view that corresponds to the first audio input device.

18. The method of claim 12 wherein positioning a view of the camera based upon a first mode further comprises:
detecting a first logic input signal of a limited duration derived from a logical switch associated with a first audio input device;
detecting a first audio input signal from the first audio input device; and
positioning the view of the camera to a predetermined view that corresponds to the first audio input device.

19. A video-follows-audio camera system comprising:
a plurality of audio inputs, each operable to detect a signal from an audio input device;
a logic controller operable to determine an input level for each of the plurality of audio inputs; and
a camera controller coupled with the plurality of audio inputs and the logic controller, the camera controller operable to generate a camera control signal for positioning a view of a camera based upon detected signals from the audio inputs and further based upon a plurality of thresholds of the input level for each detected signal.

20. The system of claim 19 wherein the plurality of thresholds comprises:
a first threshold set between a muted condition and an un-muted condition; and
a second threshold set between the un-muted condition and a speech condition.

21. The system of claim 20 wherein the camera controller selects a camera view that corresponds to an audio input having an audio signal that surpasses the first threshold if no other audio input has surpassed the first threshold.

22. The system of claim 20 wherein the camera controller selects a camera view that corresponds to an audio input having an audio signal surpassing the second threshold if no other audio input has surpassed the second threshold.

23. The system of claim 20 wherein the camera controller selects a camera view that corresponds to an audio input having an audio signal that surpasses the first threshold and having a higher priority than other audio inputs having audio signals surpassing the first threshold but not surpassing the second threshold.

24. The system of claim 20 wherein the camera controller selects a camera view that corresponds to an audio input having an audio signal that surpasses the second threshold and having a higher priority than other audio inputs having audio signals surpassing the second threshold.

25. A video-follows-audio camera system comprising:
a plurality of audio inputs, each operable to detect a logic signal and an audio signal from an audio input device;
a timer operable to determine a duration of time that a detected logic signal is present; and
a controller coupled with the plurality of audio inputs and the timer, the controller operable to generate a camera control signal for positioning a view of a camera based upon the duration of time that a detected logic signal is present and a detected audio signal.

26. The system of claim 25 wherein the controller selects a view that corresponds with an audio input that detects that a logic signal is present for more than a predetermined duration of time.

27. The system of claim 25 wherein the controller selects a view that corresponds with an audio input that detects that a logic signal is present for more than a predetermined duration of time and that has a higher priority than other audio inputs that detect a logic signal that surpass the predetermined length of time.

28. The system of claim 25, wherein the controller maintains the selected view while a corresponding audio signal is being detected.

29. The system of 28 wherein the controller maintains the selected view if the audio logic signal is not detected.
